(19) United States
(12) Patent Application Publication
(10) Pub. No.: US 2007/0165886 A1
(43) Pub. Date: Jul. 19, 2007

(54) Louderspeaker

(76) Inventors: Richard Topliss, Cambridge (GB); Anthony Hooley, Cambridge (GB); Mark Richard Shepherd, Hertfordshire (GB)

Correspondence Address: NIXON & VANDERHYE, PC, 901 NORTH GLEBE ROAD, 11TH FLOOR, ARLINGTON, VA, 22203, US

(21) Appl. No.: 10/578,876

(22) PCT Filed: Nov. 10, 2004
(86) PCT No.: PCT/GB04/04735

§ 371 Date: May 11, 2006

(30) Foreign Application Priority Data
Nov. 17, 2003 (GB) 0326721.8
Aug. 3, 2004 (GB) 0417277.1

(51) Int. Cl. H04R 25/00; H04R 9/06; H04R 11/02

(52) U.S. Cl. 381/152; 381/398

(57) ABSTRACT

A loudspeaker comprises a sound generating element mounted on a support structure, and two rotary actuators I mounted at opposing edges of the sound generating element. The actuators are operable to drive motion of the sound generating element relative to the support structure including a component of rotation. The loudspeaker produces a greater sound output than if driven at one edge only, and is particularly suitable for use in a portable electronic device such as a mobile telephone, in which case the support structure may be a portion of the casing of the, device and the sound generating element maybe a transparent panel covering a display device.

This invention relates to a loudspeaker which is particularly suitable for use in an electronic device of relatively small size as to be portable, such as a mobile phone, Personal Digital Assistant (PDA) or lap-top computer.

An example of a type of loudspeaker suitable for use in a portable electronic device is described in the commonly owned international patent application WO-03/001841. This type of loudspeaker is referred to herein as a “C-Window speaker” and comprises a sound generating element (diaphragm) driven by a “C-morph actuator”, which is a piezoelectric actuator having a bender construction and shaped as a cylinder with a sector removed (hence it is C-shaped in cross-section). One end of the actuator is attached to the sound generating element while the other end of the actuator is attached to the housing of the electronic device. In operation the ends of the actuator relatively rotate. Thus actuator is operable to drive motion of the sound generating element including a component of rotation. The C-Window speaker allows a panel in the housing of various products, such as mobile phones and PDAs, to be driven as a loudspeaker, and provides the following advantages:

the speaker is very low profile, so does not take up much room inside the product;

the C-morph actuator looks electrically like a capacitor, and consumes little power;

for products that use a display, such as mobile phones, the sound generating elements may be the polycarbonate screens currently used to protect the LCD;

use of such loudspeakers allows the product to be more effectively sealed against water and dust;

the sound produced is diffuse, preventing hearing damage if used at loud volume close to the ear;

the sound quality is superior to equivalent sized speakers; and

the parts and construction of the speaker are simple, potentially yielding cost advantages over traditional speakers.

Despite these advantages, the output sound level of the loudspeaker is limited by its size, as for any loudspeaker. In a typical use in a portable electronic device, for example in which the sound generating element is a portion of the casing of the device, the size of the device limits the size of the loudspeaker. Thus the trend for smaller electronic devices conflicts with the requirement for an incorporated loudspeaker to produce a reasonable output sound level.

According to a first aspect of the present invention, there is provided a loudspeaker comprising:

a sound generating element mounted on a support structure;

two rotary actuators mounted at opposing edges of the sound generating element and operable to drive a rotary motion of the edges of the sound generating element relative to the support structure to cause the sound generating element to generate sound.

Each actuator is mounted at an edge of the sound generating element. The two actuators are at opposing edges of the sound generating element. The actuators are rotary actuators and may be C-morph actuators of the type disclosed in WO-03/001841. Both edges of the diaphragm move with a component of rotation. The provision of drive at each edge of the diaphragm allows a greater output sound level to be produced from the sound generating element for a given area than if driven at one edge alone as disclosed in WO-03/001841. For example, the two rotary actuators may be driven by a common signal. In this case, both edges of the sound generating element are driven in concert, that is both edges move in the same direction. In this case, clearly the output sound level achievable is higher. Alternatively, the actuators may be driven by separate signals, for example two stereo signals. In this case, not only is the overall output sound level increased as compared to use of a single actuator, but further effects such as the output of stereo sound may be achieved.

Preferably, each actuator is a single element, but alternatively each actuator may be comprised of a number of actuator elements.

One end of each actuator is mounted to the diaphragm. The other end of each actuator may be mounted directly to the support structure, or alternatively it may be mounted indirectly to the support structure via another portion of the diaphragm.

The loudspeaker may be provided with a drive circuit for supplying drive signals to the actuators. In the case of supplying a separate signal to each actuator, the following features are advantageously applied.

The drive circuit may include a low frequency mixer circuit arranged to mix a low frequency component of each of the separate signals into the other of the separate signals. The low frequency component may be a component below a predetermined cut-off frequency, say 400 Hz. This has the effect that the low frequency components are to an extent combined in the sense that both actuators receive the low frequency components of each separate signal. Thus, the whole sound generating element will tend to move as one, and more effectively radiate the low frequency components, such low frequency radiation-efficiency being generally proportional to the square of the area of the radiating part of the diaphragm or panel. This approach works because as drive frequency increases the sound generating element tends to bend more and behave progressively less as a rigid co-moving body, whereas at very low frequencies it barely bends at all and operates effectively as a single stiff diaphragm.

This effect is achieved in general in a loudspeaker in which two actuators drive opposite halves of a sound generating element, even if the actuators are not rotary but are for example linear actuators. Such a loudspeaker is provided in accordance with a further aspect of the present invention.

The drive circuit may be arranged to process the separate drive signals by a head-related transfer function. This produces the perception of directional effect to a listener. Such processing by a head-related transfer function is in itself known for producing various directional effects, for example a pseudo-stereo effector a pseudo-surround sound effect. One example is the Stereo Dipole system designed by Nelson at ISVR, University of Southampton, UK.

This effect is achieved in general in a loudspeaker in which two actuators drive opposite halves of a sound generating element, even if the actuators are not rotary but are for example linear actuators. Such a loudspeaker is provided in accordance with a further aspect of the present invention.

The drive circuit may include an opposition mixer circuit arranged to derive an opposition signal from each of the separate drive signals by inversion of at least a high frequency component thereof and to mix each respective opposition signal with the other one of the separate drive signals from which the opposition signal was derived. This has the advantage of enhancing the stereo effect of the two drive signals supplied to the two actuators by effectively increasing the separation of the portions of the sound generating element from which the two sound channels seem to emanate. This is achieved by each opposition signal tending to cancel the sound being generated by the actuator at the opposite edge of the sound generating element, thereby concentrating that sound towards the opposite edge.

This effect is achieved in general in a loudspeaker in which two actuators drive opposite halves of a sound generating element, even if the actuators are not rotary but are for example linear actuators. Such a loudspeaker is provided in accordance with a further aspect of the present invention.

Advantageously, the sound generating element comprises a panel having a physical property which varies across the panel between the two actuators.

This allows a number of effects to be achieved, including enhanced decoupling of the sounds generated from separate drive signals supplied to the two actuators, or use of the sound generating element as a lens for a display device, as described in more detail below.

These effects are achieved in general in a loudspeaker in which two actuators drive opposite halves of a sound generating element, even if the actuators are not rotary but are for example linear actuators. Such a loudspeaker is provided in accordance with a further aspect of the present invention.

To allow a better understanding, embodiments of the present invention will now be described by way of non-limitative example, with reference to the accompanying drawings, in which:

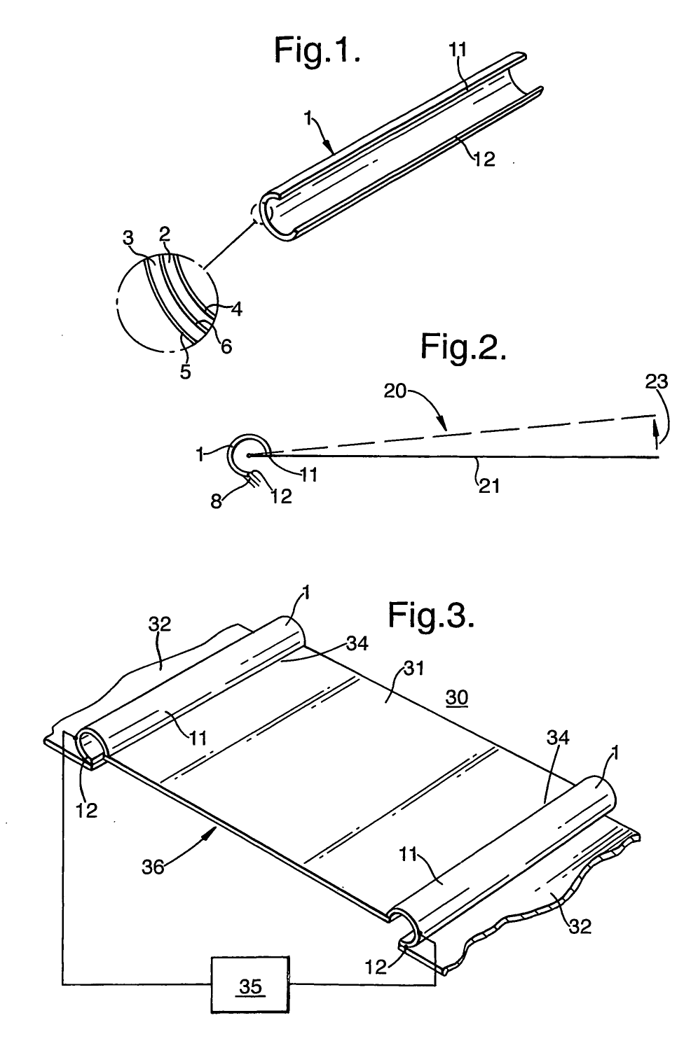

FIG. 1 is a perspective view of a C-morph actuator including a detailed view of the layered construction;

FIG. 2 is a schematic side view of a loudspeaker assembly using the actuator of FIG. 1;

FIG. 3 is a perspective view of a loudspeaker using two actuators as shown in FIG. 1;

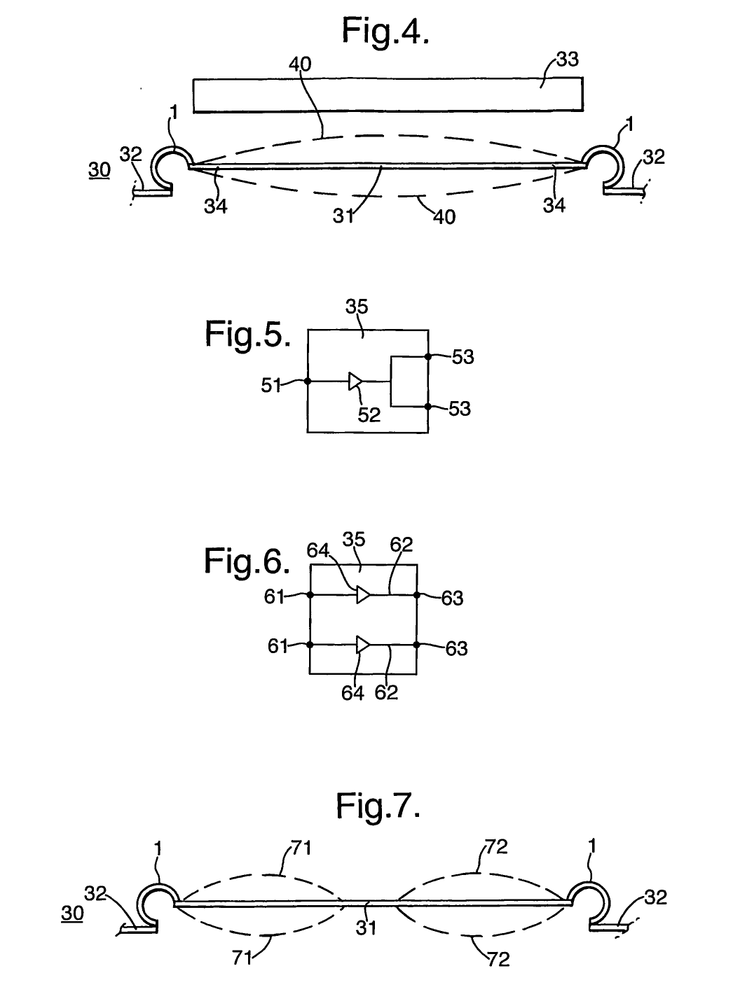

FIG. 4 is a side view of the loudspeaker of FIG. 3 in a first mode of operation;

FIG. 5 is a circuit diagram of a drive circuit for the loudspeaker of FIG. 3;

FIG. 6 is a circuit diagram of an alternative drive circuit for the loudspeaker of FIG. 3;

FIG. 7 is a side view of the loudspeaker of FIG. 3 in a second mode of operation;

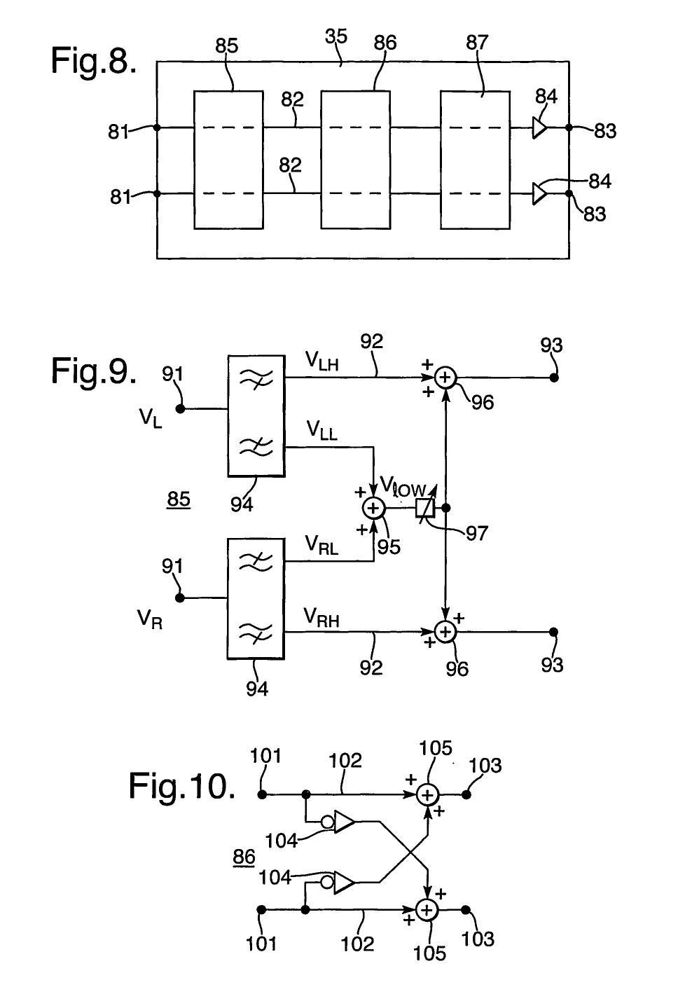

FIG. 8 is a circuit diagram of a further alternative drive circuit for the loudspeaker of FIG. 3;

FIG. 9 is a circuit diagram of a low frequency mixer circuit of the drive circuit of FIG. 8;

FIG. 10 is a circuit diagram of an opposition mixer circuit of the drive circuit of FIG. 8;

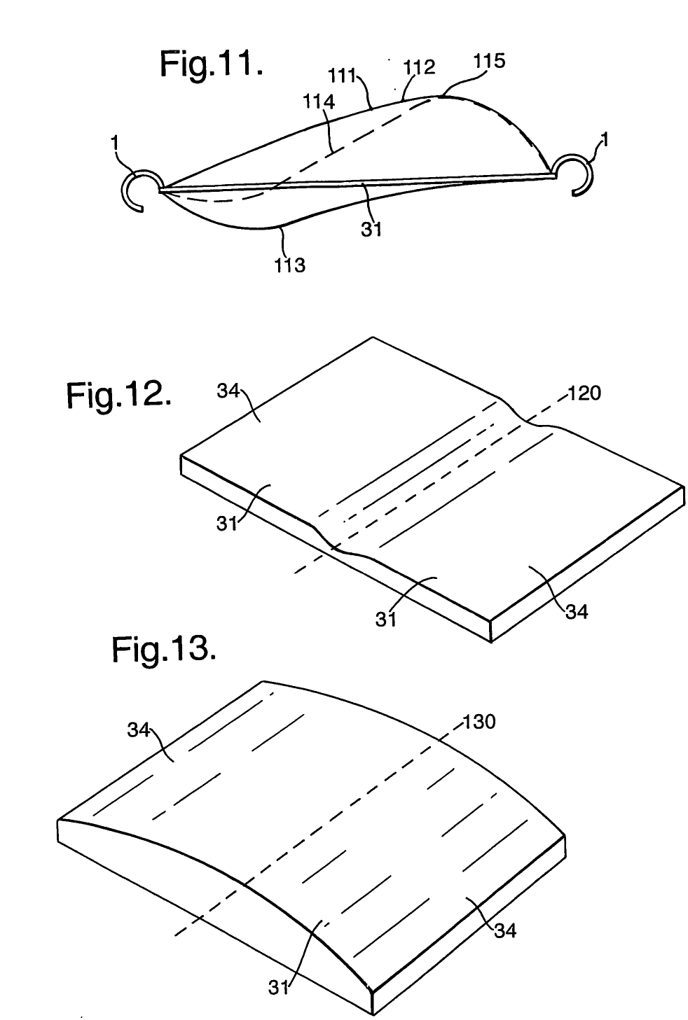

FIG. 11 is a side view of the loudspeaker of FIG. 3 showing the effect of the opposition mixer circuit;

FIG. 12 is a perspective view of a first alternative diaphragm for the loudspeaker of FIG. 3; and

FIG. 13 is a perspective view of a second alternative diaphragm for the loudspeaker of FIG. 3.

There will first be described an actuator 1 as shown in FIG. 1. The actuator 1 has a bimorph bender construction comprising two layers 2 and 3 of piezoelectric material in a layered construction interposed between two outer electrodes 4 and 5 and a central electrode 6. The piezoelectric material of the layers 2 and 3 is preferably a piezoelectric ceramic such as PZT. The layers 2 and 3 of piezoelectric material are activated by application of a voltage across the electrodes 4 to 6, the directions of poling and of the activation voltage being chosen so that layers 2 and 3 undergo a differential change in length, e.g. one layer 2 expanding while the other layer 3 contracts, thereby causing bending of the actuator 1. For example the layers 2 and 3 may be poled in the same direction and activated by a voltage in opposite directions by grounding the outer electrodes 4 and 5 and applying the voltage to the central electrode 6. The actuator 1 extends in a curve between two ends 11 and 12, in particular a sector of a circle, in this case about ¾ of a complete circle. Thus the actuator 1 is tubular in form. With this form, bending of the actuator 1 on activation causes relative rotation of the two ends 11 and 12 about the axis around which the actuator curves.

The actuator 1 is elongate in the sense that its transverse extent is greater than its extent between the two ends 11 and 12. This increases the rigidity of the coupling between the actuator 1 and a diaphragm 21 (as described below) and also increases the force applied for an actuator 1 having a given extent between its two ends 11 and 12.

FIG. 2 is a schematic diagram illustrating the operation of the actuator 1 in a loudspeaker 20 of the known type disclosed in WO-03/001841 and described above referred to as a C-Window. In this case, the actuator 1 is mechanically coupled to a diaphragm 21 to generate sound. One end 12 of the actuator 1 is mechanically coupled to a support 8 and is therefore fixed. The opposite end 11 of the actuator 1 is rigidly coupled to the diaphragm 21. When activated, the opposite end 11 of the actuator 1 rotates relative to the one end 12 which is fixed, thereby rotating the diaphragm 21 as shown schematically by the arrow 23 (in fact there being some bending of the diaphragm 21). In this manner, the actuator 1 is used to vibrate the diaphragm 21 to generate sound.

FIG. 3 shows a loudspeaker 30 in which two identical actuators 1 are used. The loudspeaker 30 has a diaphragm 31 which acts as a sound generating element. The diaphragm 31 is formed as a flat panel of material, for example polycarbonate. The diaphragm 31 is mounted by the actuators 1 to the casing 32 of a portable electronic device such as a mobile telephone, which casing 32 acts as a support structure for the loudspeaker 30. The diaphragm 31 covers an aperture 36 in the casing 32 and may therefore be considered as a part of the casing 32. The diaphragm 31 is transparent and forms the protection layer for a display device 33 housed in the casing 32 as shown in FIG. 4.

The actuators 1 are mounted at opposing edges 34 of the diaphragm 31 facing each other. Each actuator 1 is coupled in the same manner as in the known loudspeaker 20 shown in FIG. 2, that is with the one end 12 of the actuator 1 coupled by a side surface to the casing 32 and with the opposite end 11 of the actuator 1 rigidly coupled by an end surface to the diaphragm 31. The actuators 1 are coupled to the casing 32 and the diaphragm 31 by suitable adhesive to provide a rigid coupling.

As an alternative to the actuators 1 being directly coupled to the casing 32, the actuators 1 may be indirectly coupled to the casing 32 via a portion of the diaphragm 31 in the manner disclosed in co-pending International Application No. PCT/GB04/004314, the teachings of which may applied to the present invention and the contents of which are incorporated herein by reference. In this case, the loudspeaker can be manufactured as a self-contained unit which can then be simply incorporated into the casing 32 in a subsequent manufacturing step.

The diaphragm 31 may be provided with a seal member (not shown) extending around its edges where the actuators 1 are not present. The seal member may be provided on the periphery of the planar surface of the diaphragm 31 as disclosed in co-pending International Application No. PCT/GB04/004314. The primary purpose of such a seal member is to act as a seal against ingress of fluids and particulates, for which is adequate a completely flexible piece of material which does not restrain the motion of the diaphragm 31. However, it is advantageous to use a material which provides some acoustic damping as this improves the flatness of the frequency response of the loudspeaker 30. The material of the seal member may be foamed elastomer with high compliance (low stiffness), for example a polyurethane foam. For example, the Compression Force Deflection of the material of the seal member is preferably in the range 25-500 kPa, more preferably 100-300 kPa (measured at 0.2 inches/minute strain rate and 25% deflection). The Durometer hardness on the Shore “A” scale is preferably in the range 8-45, more preferably about 25. An example of a suitable material for the seal member is a polyurethane foam, for example a foam supplied under the name PORON (trade mark) by Rogers Corporation such as PORON 4701-40 Soft, preferably high density grade which has a density of 480 kg/m3, thickness 0.8 mm and typical Compression Force Deflection of 173 kPa and Shore “A” hardness of 25.

The loudspeaker 30 further comprises a drive circuit 35 for supplying a drive signal to each actuator 1. One possible arrangement for the drive circuit 35 is shown in FIG. 5. In this case, the drive circuit 35 has an input 51 for receiving an input signal which is supplied to the input of an amplifier 52 which amplifies the input signal to produce a drive signal. The output of the amplifier 52 is connected to two outputs 53 of the drive circuit 35 which are each connected to one of the actuators 1.

Thus the drive circuit 35 supplies a common drive signal to the two actuators 1. Each actuator 1 drives motion of the edge 34 of the diaphragm 31 to which it is coupled, this motion being rotary at that edge 34. As the actuators 1 are oriented in opposite directions facing each other, the common drive signal operates them to drive rotation in opposite senses about their respective axes. Thus, the actuators 1 both drive the overall motion of the diaphragm 31 in phase and in the same direction to generate sound, but with the component of rotation generated by each actuator 1 causing the diaphragm to flex. The amplitude of the resultant motion is illustrated schematically by the dotted lines 40 in FIG. 4 (in which the displacement is exaggerated for clarity). The diaphragm 31 is designed to be sufficiently flexible to accommodate the opposing rotations of the two actuators 1. That is, the material and dimensions of the diaphragm 31 are selected to provide an appropriate level of stiffness such that the diaphragm is stiff enough to effectively move the adjacent air to create sound, and flexible enough to allow its opposed edges 34 to be counter-rotated. In addition, the diaphragm 31 is stiff enough to provide adequate protection for the display device 33. For example, the diaphragm 31 may be made from a polycarbonate of the same type as is commonly used as a protective cover for a display device.

The provision of an actuator 1 at each edge 34 of the diaphragm 31 allows a greater output sound level to be produced from the diaphragm 31 for a given area of the diaphragm 31, than if driven by a single actuator 1 as disclosed in WO-03/001841.

FIG. 6 shows an alternative arrangement for the drive circuit 35 which supplies two separate drive signals to the actuators 1. In this case, the drive circuit 35 has two inputs 61 for receiving two separate input signals VL and VR, which are typically the left and right channels of a stereo signal, and supplying them along a respective signal path 62 to a respective output 63 connected to one of the actuators 1. Each signal path 62 has an amplifier 64 which amplifies the input signal to produce a drive signal. In this drive mode the left section of the diaphragm 31 will predominantly move in response to the left stereo input signal VL and the right section of the diaphragm 31 will predominantly move in response to the right stereo input signal VR due to the closer proximity of the left and right actuators 1 to the left and right edges 34 of the diaphragm 31 and because of the finite stiffness of the diaphragm 31 and of any surrounding seal member. Thus, the left and right sections of the diaphragm adjacent the two actuators 1 will tend to output the separate signals, thereby localising the acoustic emission and providing a stereo effect. This is shown schematically in FIG. 7 in which the resultant motion deriving from the first signal is illustrated schematically by the dotted line 71 and the resultant motion deriving from the second signal is illustrated schematically by the dotted line 72 (in which the displacement is exaggerated for clarity). The variation in the motion of the diaphragm 31 will be more emphasised at high frequencies than at low frequencies, because of the compliance and inertia of the diaphragm 31 and the compliance and damping of any seal member. Thus stereo “separation” will be greater at higher frequencies than lower.

FIG. 8 shows another alternative arrangement for the drive circuit 35 which also supplies two separate drive signals to the actuators 1. In this case, the drive circuit 35 again has two inputs 81 for receiving two separate input signals VL and VR, which are typically the left and right channels of a stereo signal, and supplying them along a respective signal path 82 to a respective output 83 connected to one of the actuators 1. Each signal path 82 has an amplifier 84 which amplifies the signal on the signal path 82 to produce a drive signal. However, the drive circuit 35 additionally includes circuits which process the signal before supply to the inputs of the amplifiers 84, in particular a low frequency mixer circuit 85, an opposition mixer circuit 86 and a directional effect circuit 87.

The low frequency mixer circuit 85 is shown in FIG. 9 and serves to maximise the possible low frequency output of the loudspeaker 30 by mixing a low frequency component of each of the input signals VL and VR into the other of the input signals VL and VR. The low frequency mixer circuit 85 has two inputs 91 which receive the two separate input signals VL and VR and supplies them along a respective signal path 92 (which forms part of the overall signal path 82 of the drive circuit 35) to a respective output 93. The input signals VL and VR are supplied to a frequency splitting filter 94 in each signal path 92 which filters out the low frequency components VIL and VRL of the respective input signals VL and VR and supplies the remaining high frequency components VLH and VRH of the respective input signals VL and VR along the signal paths 92. The frequency splitting filter 94 has a filter characteristic such that the low frequency components VLL and VRL are the components of the input signals VL and VR below a predetermined cut-off frequency, typically 400 Hz or below.

The low frequency components VLL and VRL are output from both filters 94 to a first adder 95 which combines them to create a combined low frequency signal Vlow. The combined low frequency signal Vlow output from the first adder 95 is supplied via an optional gain adjuster 97 to both of two second adders 96 each arranged in one of the signal paths 92 to add the gain-adjusted combined low frequency signal Vlow to the respective high frequency components VLH and VRH remaining on the signal paths 92. Thus the second adders 96 have the effect of re-introducing the combined low frequency signal Vlow into the signals on the signal paths 92.

The net effect is to mix some, perhaps half, the low frequency component VLL and VRL of each of the input signals VL and VR into the other of the input signals VL and VR. As a result, in respect of the low frequency components VLL and VRL, the whole diaphragm 31 is driven by a common signal and so tends to move as a common acoustic radiating source, as described above with reference to FIG. 4. This results in more effective radiation of the low frequency components VLL and VRL, such low frequency radiation-efficiency being generally proportional to the square of the area of the radiating part of the diaphragm 31. However, in respect of the high frequency components VLH and VRH remaining on the signal paths 92, the left and right sections of the diaphragm 31 adjacent the two actuators 1 will tend to output the separate signals, thereby providing a stereo effect, as described above with reference to FIG. 7. This approach works because as drive frequency increases the diaphragm 31 tends to bend more and behave progressively less and less as a rigid co-moving body, whereas at very low frequencies it barely bends at all and operates effectively as a single stiff body. To build an effective loudspeaker of this type, it is desirable to match the stiffness of the diaphragm 31 to the predetermined cut-off frequency of the filters 94 so that useful independent radiation may be achieved above the cut-off frequency from the two halves of the diaphragm 31 adjacent to the two actuators 1, and useful uniform radiation from the whole diaphragm 31 below the cut-off frequency.

Of course the low frequency mixer circuit 85 may have other constructions and in particular may achieve a similar effect even if an amount of the low frequency component VLL and VRL other than a half is mixed into the other of the input signals VL and VR.

The opposition mixer circuit 86 is shown in FIG. 10. It has two inputs 101 which receive the two separate input signals VL and VR and supplies them along a respective signal path 102 (which forms part of the overall signal path 82 of the drive circuit 35) to a respective output 103. The opposition mixer circuit 86 supplies the two input signals VL and VR to respective inverters 104 which invert the input signals VL and VR, and may optionally apply a gain of more or less than one, to generate respective opposition signals VLO and VRO. The opposition signals VLO and VRO are each supplied to an adder 105 in the signal path 102 of the other one of the input signals VL and VR. Thus the opposition mixer circuit 86 has the effect of inverting each input signal VL and VR and mixing it with the other of the input signals VL and VR.

The effect of the opposition mixer circuit 86 is to enhance the stereo effect by increasing the separation of the positions on the diaphragm 31 from which the two input signals VL and VR seem to emanate. This is because each opposition VLO and VRO drives the half of the diaphragm 31 adjacent the actuator 1 to which it is applied in opposition to the driving by the other actuator 1, thereby to some extent cancelling the effect of the signal VL or VR applied to that other actuator. That is the right channel is cancelled in the left half of the diaphragm 31 and vice versa. The result is enhanced separation of the two separate signals and an enhanced stereo effect. This is illustrated schematically in FIG. 11 for a single input signal VR applied to the actuator 1 on the right in FIG. 11. The input signal VR causes the diaphragm 31 to vibrate with an amplitude schematically represented by the line 111 (amplitude exaggerated for clarity). The amplitude is greater towards the right in the vicinity of the actuator 1 on the right. The right channel sound will therefore appear to come from a point to the right of the centre of the diaphragm 31, say from location 112. At the same time, the actuator 1 on the left is driven with an opposition signal VRO, that is, a negative, or partial negative, of the input signal VR applied to the actuator 1 on the right, producing a diaphragm amplitude as shown by the line 113. This opposition vibration peaks towards the left edge of the diaphragm 31. The resultant sum amplitude of the two vibrations is shown as the line 114, which displays a narrower peak than the line 111. The right channel sound will therefore appear to come from a point closer to the right-hand edge of the diaphragm 31 say from location 115. A similar effect is achieved for the input signal VL applied to the actuator 1 on the left. Compared to simple stereo drive, the separation of the two channels is increased, enhancing the stereo effect.

In practice, because of the finite speed of sound along the diaphragm 31, it may additionally be necessary to add phase-correction in the inverters 104 to ensure that an inverted amplitude at each frequency is driven into the opposing ends of the actuator i.e. the inverters 104 should phase-track the acoustic path from one actuator 1, along the diaphragm 31, to the other actuator 1.

Although the opposition mixer circuit 86 processes the input signals VL and VR supplied thereto, the effect achieved is of particular importance to the high frequency components. Therefore, as an alternative, the opposition mixer circuit 86 could extract and process solely the high frequency components for example by combining the opposition mixer circuit 86 with the low frequency mixer circuit 85 to process the signals output from the filters 94.

The directional effect circuit 87 is arranged to process the two drive signals VL and VR by a head-related transfer function which produces a perceived directional effect, for example a pseudo-stereo or a pseudo surround sound effect which causes the listener to perceive the sound to come from a location other than the loudspeaker 30. Such processing by a head-related transfer function is in itself known and may be applied to the present invention. One known example is the Stereo Dipole system designed by Nelson at ISVR, University of Southampton, UK. In such Stereo Dipole type systems, the two separate radiating loudspeakers are preferably very close to each other, and in some cases the physical sizes of the transducers to be used are the limiting factor on just how close together they may be mounted in practice. In the loudspeaker 30 of the present invention, suitable choice of actuator spacing, panel size, thickness, material and nonuniformity of physical properties, may be chosen to result in the dominantly radiating areas responsive to the left and right drive signals VL and VR, being almost any separation apart on the diaphragm 31 within the bounds of the diaphragm 31. That is, an effective acoustic transducer separation from almost zero up to the panel width may be achieved (even though the actuators driving the panel are fixed at the edges of the diaphragm 31), and what is more, this effective transducer separation can be tailored to change with frequency if so desired. Thus the loudspeaker 30 may be used to produce stereo and/or surround sound for a listener suitably positioned.

Various modifications to the structure of the loudspeaker 30 are possible.

One possibility is to change the form of the diaphragm 31. In the loudspeaker described above the diaphragm 31 is a flat planar sheet having uniform physical properties across its area. Alternatively, there can be a variation in one or more physical properties across the diaphragm 31. Some variations which have particular advantage will now be described.

In general, the diaphragm may have any form of variation, for example ribs or structure formed in any pattern. However, particular advantage is achieved by the physical property varying with mirror symmetry about a central line between the two actuators 1. In this case, the effect on the operation of both actuators 1 is the same, but some additional effect may also be achieved. The physical property may additionally or alternatively vary with mirror symmetry about a line joining the centres of the two actuators 1.

One possibility is for the physical property which varies to be the stiffness of the diaphragm 31. This allows the acoustic properties to be controlled. To vary the stiffness, it is possible to vary the material of the diaphragm 31 to be inhomogeneous so that its density, or modulus, or both vary as a function of position. However, variation in stiffness is more conveniently achieved with a material of uniform composition across the diaphragm 31 and varying the thickness (i.e. that panel dimension perpendicular to the forward direction in which sound is predominately radiated).

One preferred example of this is shown in FIG. 12 which shows an alternative form for the diaphragm 31 in which the thickness, and hence stiffness, is lower along a central line 120 between the edges 34 to which the actuators 1 are coupled. This form for the diaphragm 31 assists with decoupling the separate acoustic radiation modes of the two halves of the diaphragm 31 driven by the separate drive signals to the two actuators 1, thereby enhancing the stereo effect when heard by a listener in front of the loudspeaker 30.

Where the diaphragm 31 of the loudspeaker 30 is to be used as a transparent, possibly protective, window in front of the display device 33, it is desirable to make only smooth changes of thickness of diaphragm 31 with position so as to minimise optical distortions by the diaphragm 31 of the image on the display device 33.

FIG. 13 shows another alternative form for the diaphragm 31 in which the thickness varies across the diaphragm 31 so that the diaphragm 31 acts as a lens. In particular, the thickness increases smoothly towards the centre line 130 between the actuators 1, so that the diaphragm 31 constitutes a lens providing some magnification of the image on the underlying display device 34. As the thickness is constant along lines parallel to the centre line 130, the lens thus formed is of the type known as a cylindrical lens, although the shape need not be exactly cylindrical. Alternatively, there may also be variation in thickness along lines parallel to the centre line 130 to form a spherical lens to magnify the image on the display device 34, although the shape need not be exactly spherical.

Although FIGS. 12 and 13 show variations in thickness on only one side of the diaphragm 31, the other side being flat, in practice these variations may occur on either or both sides (i.e. one side may be flat, the other profiled, or both profiled).

Alternatively variations in other physical properties as a function of position may be used to cause the diaphragm 31 to act as a lens.

Any and all combinations of physical property variations described above may be combined in the one diaphragm 31, so that for example the diaphragm 31 might be thinner towards the middle, lower modulus towards the middle and higher density towards the edges, the variations of panel properties then being chosen to additively increase or minimise the associated optical effects where the panel is transparent, and/or to increase or minimise the dependent panel property, namely panel stiffness, as a function of position.

1. A loudspeaker comprising:
a sound generating element mounted on a support structure;
two rotary actuators mounted at opposing edges of the sound generating element and operable to drive motion of the sound generating element relative to the support structure by rotating said edges.

2. A loudspeaker according to claim 1, wherein the two rotary actuators are operable to drive motion including components of rotation in opposite senses if driven with a common drive signal.

3. A loudspeaker according to claim 1o, wherein the two rotary actuators are identical.

4. A loudspeaker according to claim 1, wherein the rotary actuators are piezoelectric actuators.

5. A loudspeaker according to claim 4, wherein the rotary actuators have a bender construction.

6. A loudspeaker according to claim 4, wherein the rotary actuators each extend in a curve between the sound generating element and the support structure.

7. A loudspeaker according to claim 6, wherein the curve is an arc of a circle.

8. A loudspeaker according to claim 4, wherein each rotary actuator is longer in extent along the axis about which said rotation occurs on operation than in extent between the ends of the actuator which rotate on operation.

9. A loudspeaker according to claim 4, wherein the rotary actuators are each coupled at one end to the sound generating element and at the other end to the support structure.

10. A loudspeaker according to claim 1, further comprising a drive circuit for supplying a common drive signal to each actuator.

11. A loudspeaker according to claim 1, further comprising a drive circuit for supplying a separate drive signal to each actuator.

12. A loudspeaker according to claim 11, wherein the drive circuit includes a low frequency mixer circuit arranged to mix a low frequency component of each of the separate drive signals into the other of the separate drive signals.

13. A loudspeaker according to claim 12, wherein the low frequency mixer circuit comprises:
two signal paths each for supplying one of the separate drive signals to a respective actuator;
a filter arrangement arranged in each signal path to filter out said low frequency components of the two separate drive signals;
a signal processing circuit arranged to combine the low frequency components of the two separate drive signals filtered out by the filter arrangement and to re-introduce the combined low frequency components into each of the signal paths.

14. A loudspeaker according to claim 12, wherein the low frequency component is a component in a frequency band below a predetermined cut-off frequency.

15. A loudspeaker according to claim 14, wherein the predetermined cut-off frequency is 400 Hz or less.

16. A loudspeaker according to claim 11, wherein the drive circuit is arranged to process the separate drive signals by a head-related transfer function.

17. A loudspeaker according to claim 11, wherein the drive circuit includes an opposition mixer circuit arranged to derive an opposition signal from each of the separate drive signals by inversion of at least a high frequency component thereof and to mix each respective opposition signal with the other one of the separate drive signals from which the opposition signal was derived.

18. A loudspeaker according to claim 1, wherein the sound generating element comprises a sheet having a physical property which varies across the sheet between the two actuators.

19. A loudspeaker according to claim 18, wherein said physical property varies across the sheet with mirror symmetry about a central line between the two actuators.

20. A loudspeaker according to claim 18, wherein said physical property is stiffness.

21. A loudspeaker according to claim 20, wherein the stiffness of the sheet is lower along a central line between the two actuators than in portions on either side of the central line.

22. A loudspeaker according to claim 20, wherein the sheet comprises a material having uniform composition across the sheet and the thickness varies across the sheet between the two actuators.

23. A loudspeaker according to claim 18, wherein said physical property is thickness.

24. A loudspeaker according to claim 23, wherein the sheet is transparent and disposed above a display device and the thickness varies across the sheet between the two actuators so that the sheet forms a lens.

25. A loudspeaker according to claim 1, wherein the support is a portion of a housing of an electronic device.

26. A loudspeaker according to claim 25, wherein the sound generating element is transparent and covers a display device.

27-28. (canceled)

29. A loudspeaker comprising:
a sound generating element mounted on a support structure;
two actuators mounted in opposite halves of the sound generating element and operable to drive motion of the sound generating element relative to the support structure; and
a drive circuit for supplying a separate drive signal to each actuator, including an opposition mixer circuit arranged to derive an opposition signal from each of the separate drive signals by inversion of at least a high frequency component thereof and to mix each respective opposition signal with the other one of the separate drive signals from which the opposition signal was derived.

30. A loudspeaker comprising:
a sound generating element mounted on a support structure;
two actuators mounted in opposite halves of the sound generating element and operable to drive motion of the sound generating element relative to the support structure, the sound generating element comprising a sheet having a physical property which varies across the sheet between the two actuators.

31. A loudspeaker according to claim 1, wherein the sound generating element is planar.

32. A loudspeaker according to claim 10, wherein the drive circuit is arranged to supply the common drive signal to each actuator to drive rotation of the two actuators in opposite senses.
